(19) United States
(12) Patent Application Publication
(10) Pub. No.: US 2016/0043814 A1
(43) Pub. Date: Feb. 11, 2016

(54) METHOD AND UNIT OF MONITORING OPERATIONAL STATUS OF A PLURALITY OF BASE STATION SITES IN A WIRELESS TELECOMMUNICATION NETWORK

(71) Applicant: PowerOasis Limited, Swindon, Wiltshire (GB)

(72) Inventor: Peter BISHOP, Purton (GB)

(21) Appl. No.: 14/781,500

(22) PCT Filed: Apr. 4, 2014
(86) PCT No.: PCT/GB2014/051057

§ 371 Date: Sep. 30, 2015

(30) Foreign Application Priority Data
Apr. 5, 2013 (GB) 1306186.6

(51) Int. Cl. H04B 17/10; H04L 12/26; H04L 5/00; H04W 24/04

(52) U.S. Cl. CPC H04B 17/10; H04W 24/04; H04L 43/06; H04L 5/005; H04L 43/0805

(57) ABSTRACT

A method of monitoring operational status of a plurality of base station sites in a wireless telecommunication network, a computer program product and monitoring unit operable to perform that method. The method comprises: receiving an indication of an operational characteristic of at least one power supply provided at least one of the plurality of base station sites; analysing the operational characteristic to determine to whether the base station site is operational; and providing an indication of determined operational status in respect of the plurality of base station sites in a wireless telecommunication network. Aspects recognise that monitoring operational characteristics of cell site power usage and similar power parameters may provide information to a central controller which can be of use in maintaining an operational telecommunications network in the event of a disaster or similar.

### FIELD OF THE INVENTION

The present invention relates to a method of monitoring operational status of a plurality of base station sites in a wireless telecommunication network, a computer program product and monitoring unit operable to perform that method.

### BACKGROUND

Wireless telecommunication systems are known. In such systems, mobile communication devices (for example, mobile telephones) are operable to communicate with base stations provided by network providers.

In known wireless telecommunication systems, radio coverage is provided to network connectable devices, such as mobile telephones, or wireless devices such as iPads or other similar tablets, within areas known as cells. A base station is located in each cell to provide radio coverage. Typically, network connectable devices in each cell are operable to receive information and data from a base station and to transmit information and data to a base station.

User equipment roam through a wireless communications system. Base stations are typically provided which support areas of radio coverage. A number of such base stations are provided and are distributed geographically in order to provide a wide area of coverage to user equipment.

Cellular networks are particularly important in relation to establishment and maintenance of communication in an emergency , disaster or accident scenario.

Post disaster event analysis, such as that performed after hurricanes Katrina and Isaac has led to recognition that maintenance of a functional cellular network can be advantageous.

It is desired to provide methods and techniques to provide a robust cellular network in the event of a disaster.

### SUMMARY

Accordingly, a first aspect provides a method of monitoring operational status of a plurality of base station sites in a wireless telecommunication network, the method comprising: receiving an indication of an operational characteristic of at least one power supply provided at least one of the plurality of base station sites; analysing the operational characteristic to determine whether the base station site is operational; and providing an indication of determined operational status in respect of the plurality of base station sites in a wireless telecommunication network.

The first aspect recognises that “after event” analysis of Katrina, Isaac and the storm of June 2012 highlighted many failings with both the monitoring and management of cell sites, which resulted in avoidable extended service outages. Similar findings are likely to result from investigations following telecommunications outages which occurred during Hurricane Sandy.

Typical cell site monitoring methods in disaster scenarios may operate to examine cellular data traffic handled by each cell and may, for example, utilise user equipment roaming through a geographical region to offer a report back to a central controller which may operate to collate a status report in relation to those cell cites which are still operational enough to handle voice or data traffic.

Aspects recognise that telecommunication network operators may seek to implement a comprehensive disaster management platform in relation to base stations distributed geographically to support their network. Furthermore, aspects and embodiments described may provide a means for a network operator to take control of their energy management in the network to reduce costs and improve availability. Aspects described further below may be operable to provide a detailed insight into the status of power systems across cellular base station sites, but can also be used to monitor power usage and environment at similar core network, switch sites and network operation centres.

The first aspect recognises that monitoring operational characteristics of cell site power usage and similar power parameters may provide information to a central controller which can be of use in maintaining an operational telecommunications network in the event of a disaster or similar. For example, even if a cellular base station is operable to provide cellular services, the ability to continue to do so may be restricted if it is running on batteries which can, as a result of a disaster event, no longer be recharged. The first aspect recognises that in order to determine the ability of a site to continue to provide service following a utility supply outage, it is helpful to understand the status of any back-up batteries or a fuel supply provided at the cellular site. Similarly, it can be useful to ascertain an operational status of any generator or fuel cell provided at a cellular site.

The first aspect recognises that in order to understand which, if any, corrective actions need to be taken to maintain or restore power at a cellular base station site following, for example, a disaster event, a network operator may make use of a complete, up to date, view of power equipment status at each remote site.

The first aspect recognises that although there may be separate battery monitoring to systems, grid monitoring systems, or fuel monitoring systems at one or more cell sites of a network, unless those systems are interconnected the data collected cannot be processed simultaneously to provide a network operator with a holistic view of site status across a network. From post hurricane Katrina and Isaac reports it is clear that many sites have little or no monitoring capability and the first instance that an operator is aware of a problem at a cell site can be when the site goes off air, which is visible at a RAN OMC. In many cases, the only method of determining power equipment status at a cellular site can be for someone to travel to visit it. Thus, in some networks, recording and reporting of cell site power status is largely manual and subject to errors and inaccuracies.

Aspects recognise that providing an accurate and comprehensive view of the status of power and power generating equipment at telecommunications installations can be beneficial. Aspects and embodiments described may allow automatic collection, collation and processing of cell site power information to provide an indication of capability of a cell site to sustain continued operation and for how long.

Aspects and embodiments described herein can provide a method and apparatus operable to perform comprehensive monitoring of power handling and power consumption devices at a site to allow an operator to form a picture of the integrity of power flows on each remote site.

In one embodiment, the at least one power supply comprises grid power and analysing the operational characteristic comprises determining whether the base station site has available grid power.

In one embodiment at least one power supply comprises a supplementary power supply and analysing the operational characteristic comprises determining whether the base station site has an available supplementary power supply.

In one embodiment, the method comprises determining whether the base station site has an available supplementary power supply and, if so, analysing measured operational parameters at the base station to determine the status of the available supplementary power supply.

In one embodiment, providing an indication of determined operational status comprises an indication of base station run time based on available power supply.

In one embodiment, providing an indication of determined operational status comprises an indication of base station failure based on a determination of no available power supply.

In some embodiments, an independent uninterruptable power supply (UPS) can be provided at each remote site. The UPS is typically provided to allow continued running of components necessary to maintain operation of a monitoring solution in accordance with the first aspect in the event of a power failure on a cellular site. Similarly, in some embodiments, a robust communication link to a central server in relation to monitoring data flow can assist in maintaining a means of automatic analysis and reporting in relation to an actual situation on each site.

A method and apparatus in accordance with aspects described may provide a centralised monitoring platform. That centralised monitoring may be configured to provide flexible reports in relation to power status of cellular sites in a network. Such reports can be configured to produce, for example, local, regional or network-wide site status summaries. Such reports may, for example, be produced in various formats. In one embodiment, it may be possible to produce a site status summary report having a format compatible with the FCC Network Outage Reporting System and Disaster Information Reporting System or, for example, a format specified by a government agency or official body.

According to some embodiments, examination and collation of data relating to power supply parameters of a set of cell sites may enable prioritisation of cell sites to occur in relation to repair or restoration work.

In some embodiments, it will be recognised that cell sites can be prioritised for attention based upon criteria including, for example, criticality of a cell site, remaining back up power available, and similar.

Aspects and embodiments may provide a method and apparatus configured to automatically produce a prioritised list according to predefined criteria to determine an order in which sites in a network should receive maintenance or repair visits. Such prioritisation may be used following a disaster event in order to best sustain continued operations according to predefined criteria selected on the basis of operator or deployment need.

Aspects and embodiments may provide a method and apparatus configured to automatically produce s status report for a geographical region or topographical region, that report indicating the status of all telecoms sites being monitored.

Aspects and embodiments may provide a method and apparatus configured to automatically send a site or network status report in a format compatible with, for example, the FCC DRIS and NORS systems.

A second aspect provides a computer program product operable, when executed on a computer, to perform the method of the first aspect.

A third aspect provides a monitoring unit operable to monitoring operational status of a plurality of base station sites in a wireless telecommunication network, the monitoring unit comprising: reception logic operable to receive an indication of an operational characteristic of at least one power supply provided at least one of the plurality of base station sites; analysis logic operable to analyse the operational characteristic to determine whether the base station site is operational; and report logic operable to provide an indication of determined operational status in respect of the plurality of base station sites in a wireless telecommunication network.

In one embodiment, the at least one power supply comprises grid power and the analysis logic is operable to determine whether the base station site has available grid power.

In one embodiment, the least one power supply comprises a supplementary power supply and the analysis logic is operable to determine whether the base station site has an available supplementary power supply.

In one embodiment, the analysis logic is operable to determine whether the base station site has an available supplementary power supply and, if so, to analyse measured operational parameters at the base station to determine the status of the available supplementary power supply.

In one embodiment, the report logic is operable to provide an indication of determined operational status which comprises an indication of base station run time based on available power supply.

In one embodiment, the report logic is operable to provide an indication of determined operational status which comprises an indication of base station failure based on a determination of no available power supply.

According to one embodiment, the method comprises determining an indication of network traffic load supported by the at least one base station site; analysing the indication of network traffic load and the operational characteristic of at least one power supply to provide an indication of an operational status of the base station site. Accordingly, it may be possible to take into account wireless communication load at each of the base station sites to provide an indication, for example, of likely base station run time or ability of the base station site to handle more network traffic load.

In one embodiment, the method comprises determining an indication of an environmental condition at the at least one base station site; and analysing the indication of environmental condition and the operational characteristic of at least one power supply to provide an indication of an operational status of the base station site. Accordingly, the environmental condition may, for example, comprise an indication of water ingress or intruder ingress or other similar ambient environmental condition experienced at each base station site. That information may be used, for example, in conjunction with information regarding available power supply information to form a picture of the operational status of each base station site.

In one embodiment, the method may comprise transmitting a wireless signal and determining whether at least one of the plurality of base station sites is operable to receive the wireless signal. According to some embodiments, the results of transmission and monitoring for receipt of the transmitted wireless signal at each of the plurality of base station sites may be used in conjunction with the determined indication of operational characteristic of at least one power supply to provide an indication of the operational status of the base station site. Accordingly, it is recognised that a base station site may have access to power and yet be unable to receive a wireless signal, thereby rendering the base station site of less use in maintaining a wireless to telecommunication network. According to some embodiments, it is possible to provide a network ping and monitor for the result of that network ping. According to some embodiments, the result of the network ping may be used in conjunction with the determined indication of operational characteristic of at least one power supply to provide an indication of the operational status of the base station site. Use of a network ping may allow checking of a round trip path within a network, thus allowing for a system check in relation to a particular base station site.

According to one embodiment, the method may comprise monitoring for a pilot signal from at least one of the plurality of base station sites and analysing those monitoring results in conjunction with the operational characteristic of at least one power supply to provide an indication of an operational status of the base station site. Accordingly, such an arrangement may recognise that each base station may be operable to hear transmissions made by neighbouring base stations and to send a report regarding receipt or otherwise of pilot signals from adjacent base station sites and that information may be used in conjunction with information regarding a power supply at neighbouring base station sites to form a picture of the operational status of adjacent base station sites. It will be understood that a pilot signal may comprise a “beacon” signal, in relation to, for example, an 802.11 network and analogous identifier broadcast transmissions made by base stations across radio access technologies.

Aspects and embodiments recognise that a method of monitoring in accordance with the first aspect may be performed across operators. In other words, it may be possible to provide intra or inter operator monitoring. Such monitoring may be of particular use to emergency services using a communication network or other independent body requiring information regarding the status of a wireless telecommunication network.

According to some embodiments, the monitoring functionality may occur as a result of an independent monitoring unit or detector unit provided at each of the plurality of base station sites. That apparatus may have independent power and/or backhaul communication capability to that provided to support the base station site itself.

Aspects and embodiments recognise that it may be possible for emergency services, government agency or official body, for example, police or similar, to use one or more commercial cellular networks instead of a Private Mobile Radio (PMR) for communication. A method according to the first aspect may be of use when monitoring to the operational status of one or more commercial cellular baste station sites operable to support non-commercial traffic. A monitoring method in accordance with the first aspect may be of use if seeking to maintain emergency or essential communications using one or more commercial base station sites, which can be less resilient by design than robust emergency-only communications networks.

A method and apparatus in accordance with aspects and embodiments described may be performed by a network operator in relation to their own plurality of base station sites, but may also be performed by a third party, independently of a network operator. Similarly, the method and apparatus may be configured to operate across base station 20 sites provided by more than one network operator, and/or across more than one Radio Access Technology (RAT) provided by one or more network operators.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

Embodiments of the present invention will now be described further, with reference to the accompanying drawings, in which:

FIG. 1 illustrates main components of a telecommunications network;

FIG. 2 illustrates schematically components of a telecommunication site in accordance with one embodiment;

FIG. 3 illustrates schematically a network monitoring system in accordance with one embodiment;

FIG. 4 illustrates schematically an example of site specific analysis which may be performed by a local or central monitoring control unit according to embodiments;

FIG. 5 illustrates schematically an example format of a report produced according to one embodiment;

FIG. 6 illustrates an alternative example format of a report produced according to one embodiment; and

FIG. 7 provides an appendix relating to parameters which may be monitored and reported according to one embodiment.

### DESCRIPTION OF THE EMBODIMENTS

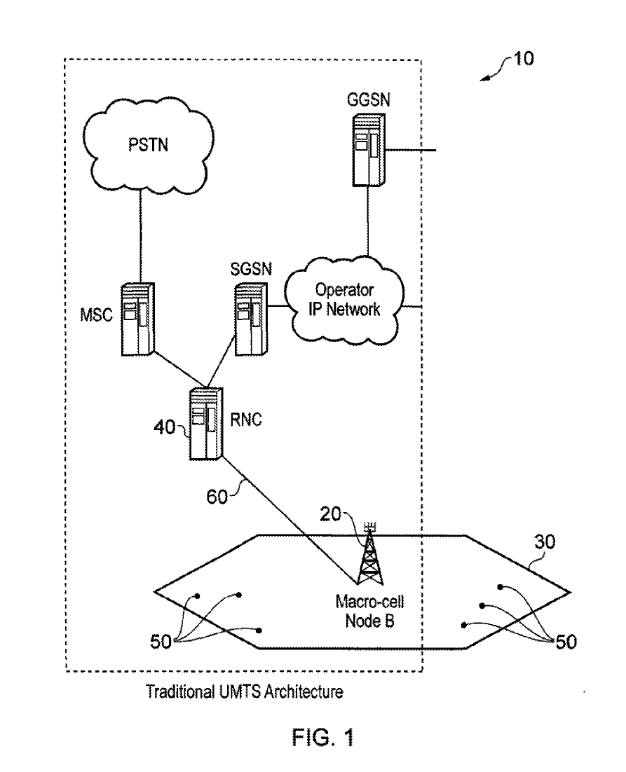

FIG. 1 illustrates schematically the main components of a wireless telecommunications network to. In the UMTS network architecture illustrated user equipment so roam through the wireless telecommunications system. Base stations 20 are provided which support areas of radio coverage 30. A number of such base stations 20 are provided and are distributed geographically in order to provide a wide area of coverage to user equipment 50.

When user equipment is within an area served by a base station 30, communications may be established between the user equipment and the base station over associated radio links. Each base station typically supports a number of sectors within the geographical area of service 30.

Typically, a different antenna within a base station supports each associated sector. Each base station 20 has multiple antennas. It will be appreciated that FIG. 1 illustrates a small subset of a total number of user equipment and base stations that may be present in a typical communication network. It will also be appreciated that different network architectures may be implemented, including, for example a Long Term Evolution (LTE) network in which the functionality provided by network nodes described above is provided by network nodes which are named differently but have analogous functionality. Aspects described herein may be applied to all radio sites including cellular networks operating according to all standards, emergency service networks, private mobile radio and broadcast networks.

### Overview

Before discussing the embodiments in any more detail, first an overview will be provided. Aspects and embodiments relate to a system which is configured to use sensors provided at a base station site to determine an indication of operational status of each base station site. That data can be relayed back to a central database where analysis and reports are prepared, ultimately producing, for example, regional reports offering a picture of on-site status of a network to a network operator or third party, for example, the FCC or other government agency or regulatory body.

### Examples of Implementations

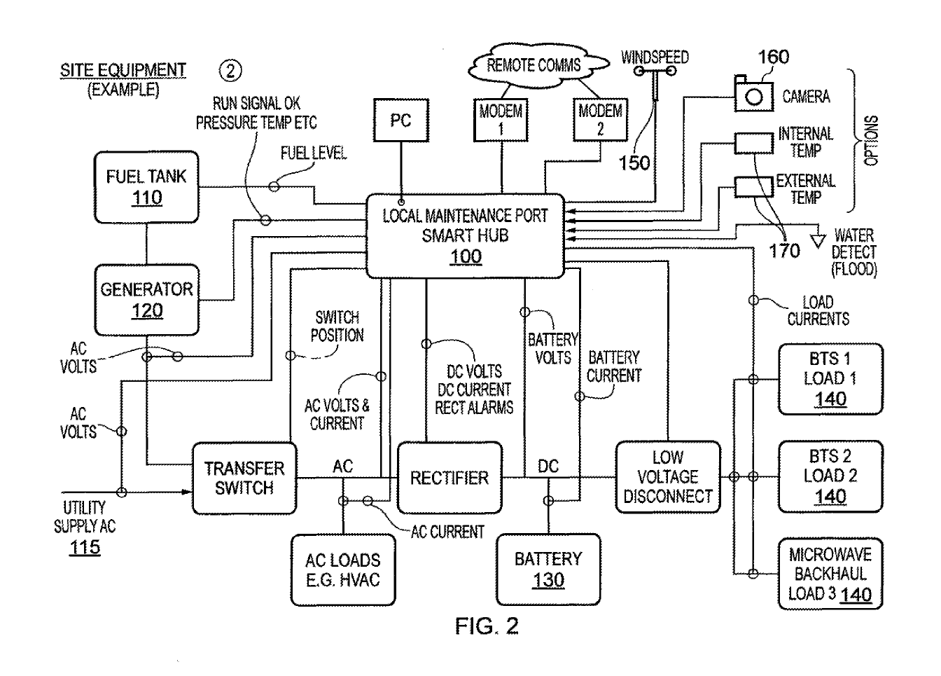

It will be appreciated that each cell, or base station, site in a network may be provided with power equipment. FIG. 2 illustrates schematically components of a telecommunication site in accordance with one embodiment. As shown in FIG. 2, in accordance with one embodiment, a local monitoring control unit too is provided at each cell site. That local monitoring control unit may be configured to receive input data from various components provided on site, including, for example, the level of fuel in a fuel tank 110, status of an a.c. supply 115, operational parameters of a generator 120, operational parameters of a rechargeable battery 130, and base station loads 140. Furthermore, specific monitoring sensors may be provided at a site, including, for example, an anemometer 150, a camera 160, temperature sensors 170.

In the illustrated embodiment, local monitoring control unit too is operable to communicate with a central monitoring unit via a dedicated backhaul link or, for example, via an IP link or similar.

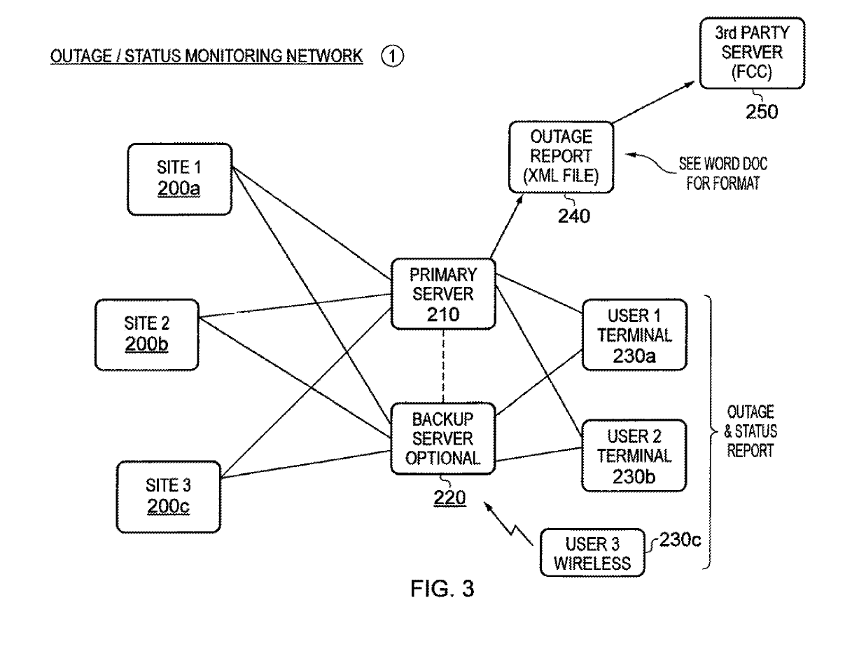

FIG. 3 illustrates schematically a network monitoring system in accordance with one embodiment. Each base station site 200a, 200b, 200c, similar to that described in relation to FIG. 2, is provided with a local monitoring control unit. That local monitoring control unit is configured to communicate data collected at the local site to a central monitoring control unit, 210. In some embodiments, each local monitoring control unit may be operable to also communicate collected data to a backup central monitoring site 220.

The central monitoring control unit may be configured to analyse data provided by the local monitoring units to provide a suitable report to, for example network operators 230a, 230b, 230c, or in a specific format to a third party. In the example shown in FIG. 3, the central monitoring control unit is configured to produce and outage report 240 as an XML file in a format acceptable to the FCC and, for example, automatically forward that report to an FCC server in the case when it is requested. In other embodiments, the central control unit may be operable to generate a report on command by a network operator for review and sign off before forwarding to, for example, a third party, such as the FCC. In some embodiments, an automatically generated report can be supplemented by, for example, manual compilation or additional data. For example, if not all the sites in a region are equipped with a local monitoring system, the automatic data collected may need to be combined with manually gathered data.

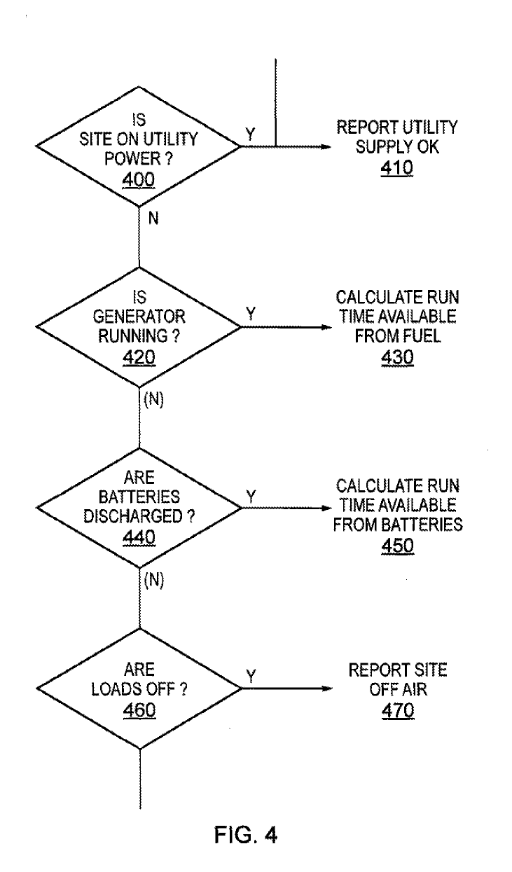

FIG. 4 illustrates schematically an example of site specific analysis which may be performed by a local or central monitoring control unit according to embodiments. In the analysis shown schematically in FIG. 4, a control unit (local or central) may be operable to determine, based upon monitored characteristics at a base station site, to determine 400 whether a site is using utility power. If yes, then the system may be configured to return an indication 410 that a site utility power supply is ok. If no, then the control unit may analyse data to determine 420 whether a generator is running. If yes, then an analysis may be carried out in relation to possible run time based on fuel level 430. The control unit may also be configured to determine, from data provided, whether batteries provided on site are discharging 440, and if so, to determine 450 a run time available from batteries, based, for example, on site load. The control unit may be configured to determine 460 whether base station loads are off. In some embodiments, if a control unit determines that the answer to 400, 420, 440 are no and the answer to 460 is yes, the control unit may return an indication that a base station site is off air 470.

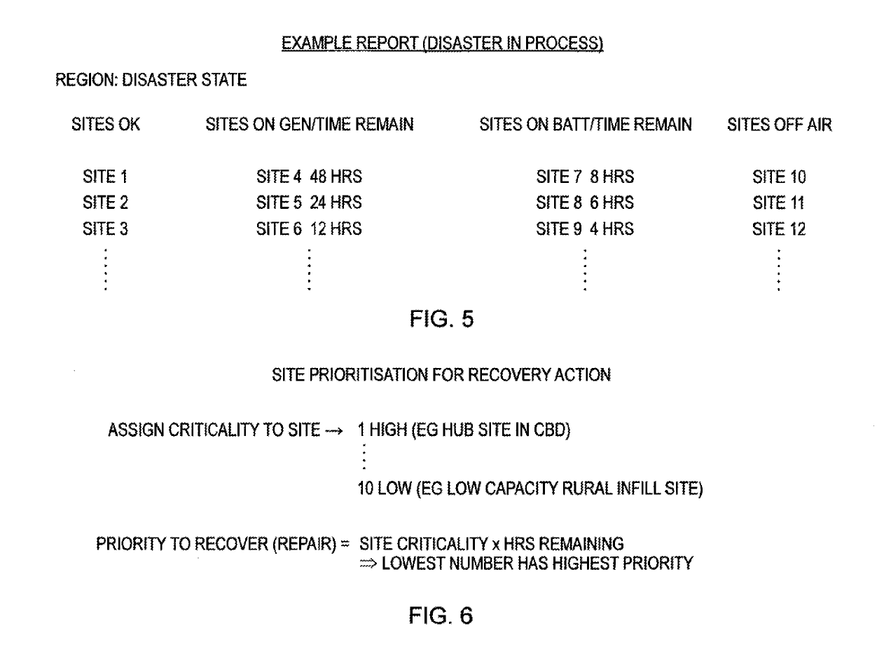

FIG. 5 illustrates schematically an example format of a report produced according to one embodiment. In the example report shown in FIG. 5, a report is produced for cell sites within a disaster state or county. The report may include an indication of sites which are determined to be operating ok, sites which are operating on generator power or battery power and their remaining power calculated in hours. The report also indicates which sites have been assessed to be non-operational.

FIG. 6 illustrates an alternative example format of a report produced according to one embodiment. In the example report of FIG. 6, a central control unit may maintain a list or look up table relating to an importance of each base station site in a network. A hub site in a central business district, for example, may be assigned a high priority and a site in a low-capacity rural infill site may be allocated a low priority. A control unit may be operable to produce a report to assist maintenance of a network or repair work based on a combination of site priority and power equipment status at each site. The report may, for example, take the form of a list indicating site criticality and hours of remaining run time.

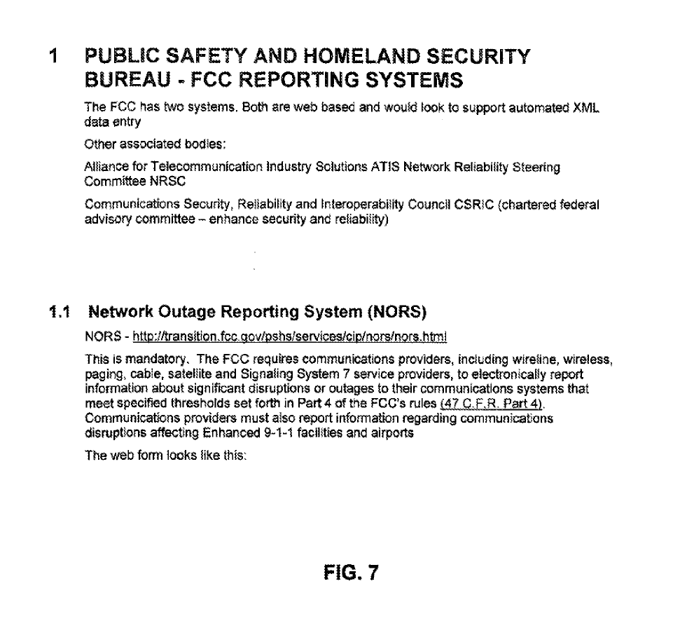

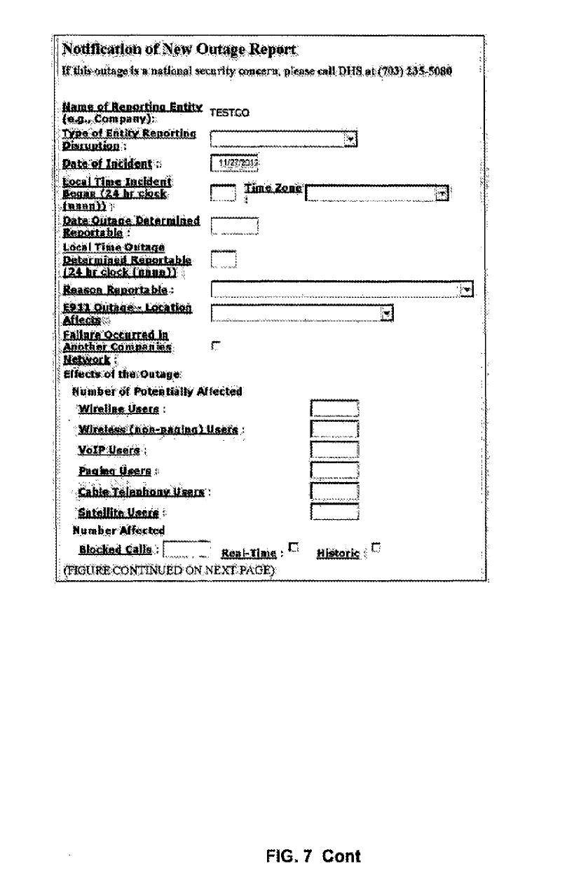

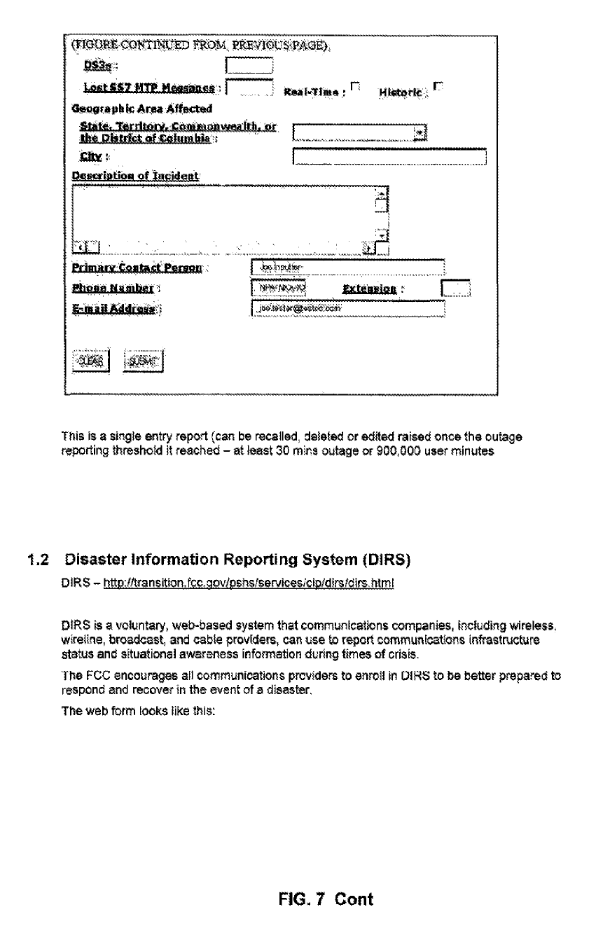

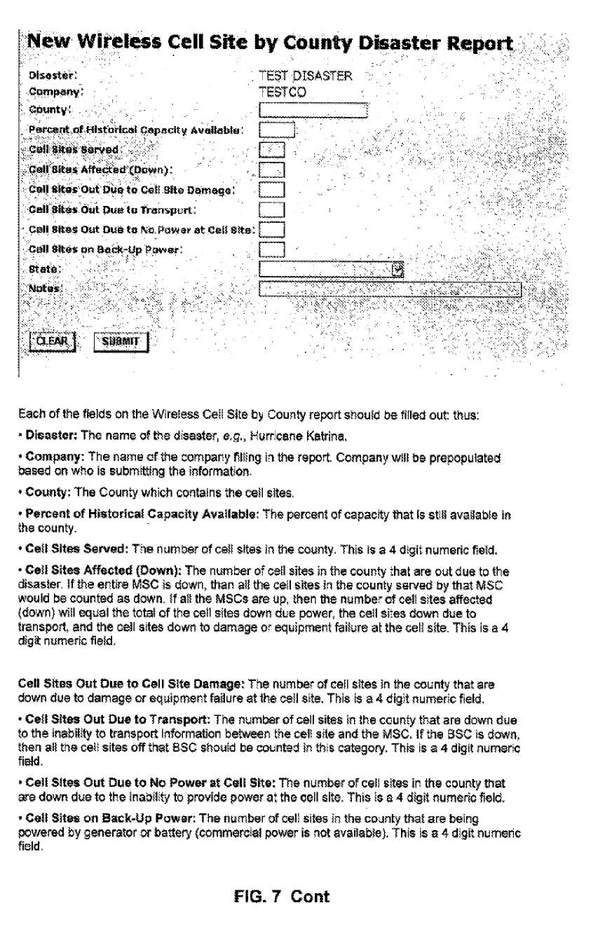

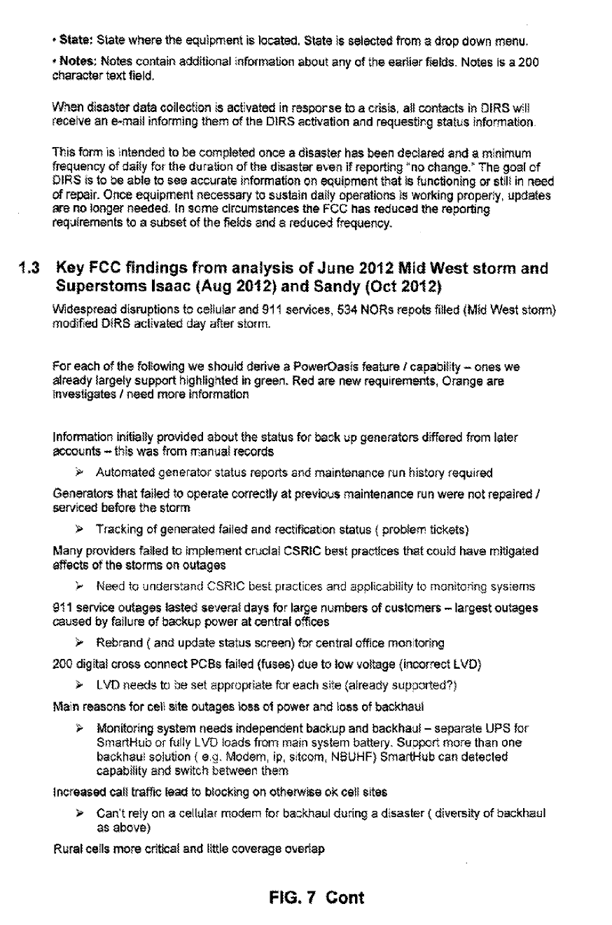

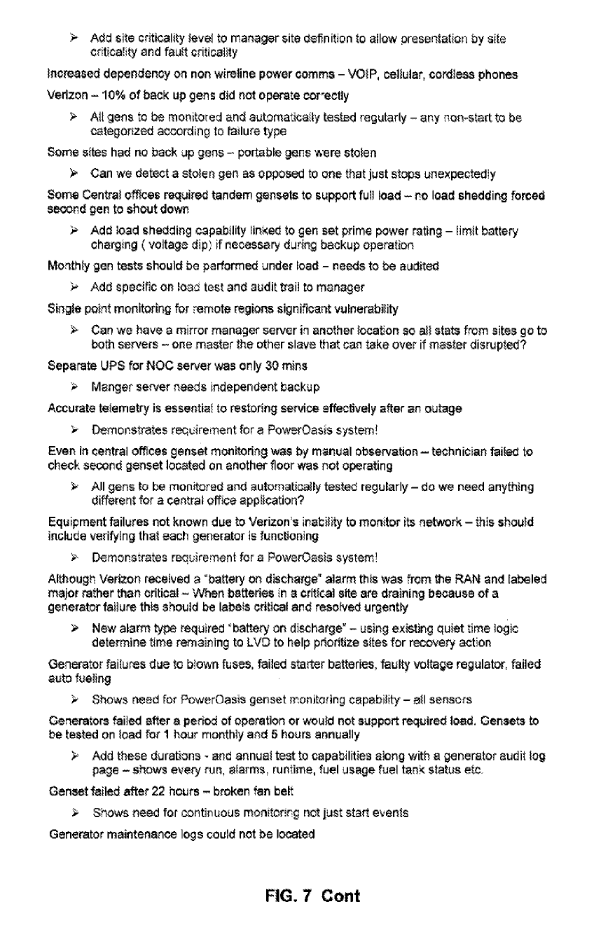

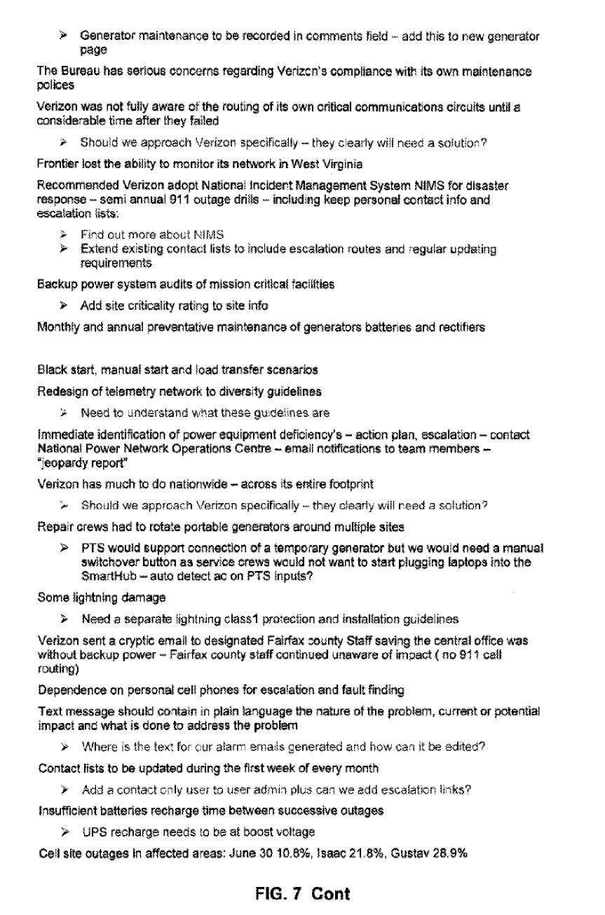

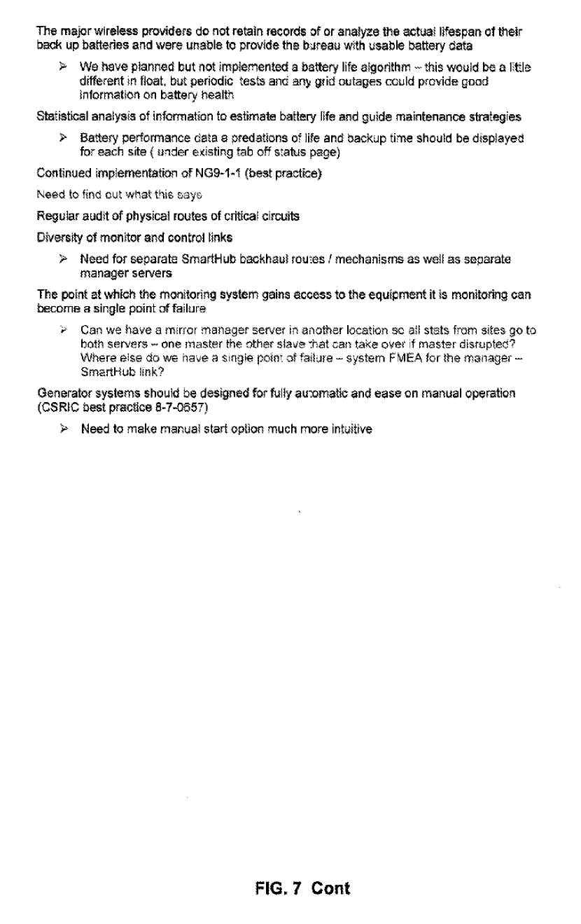

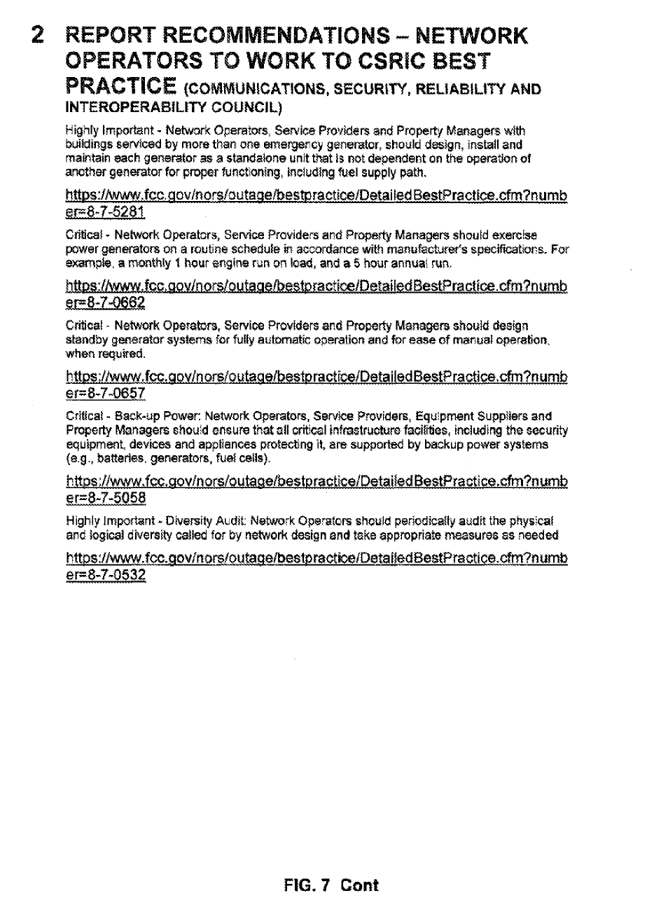

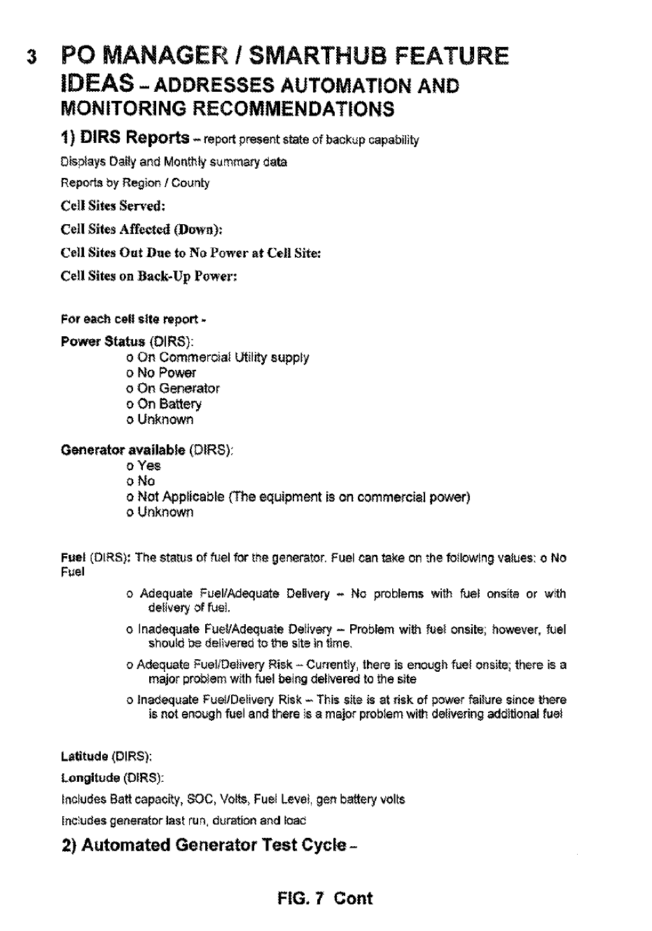

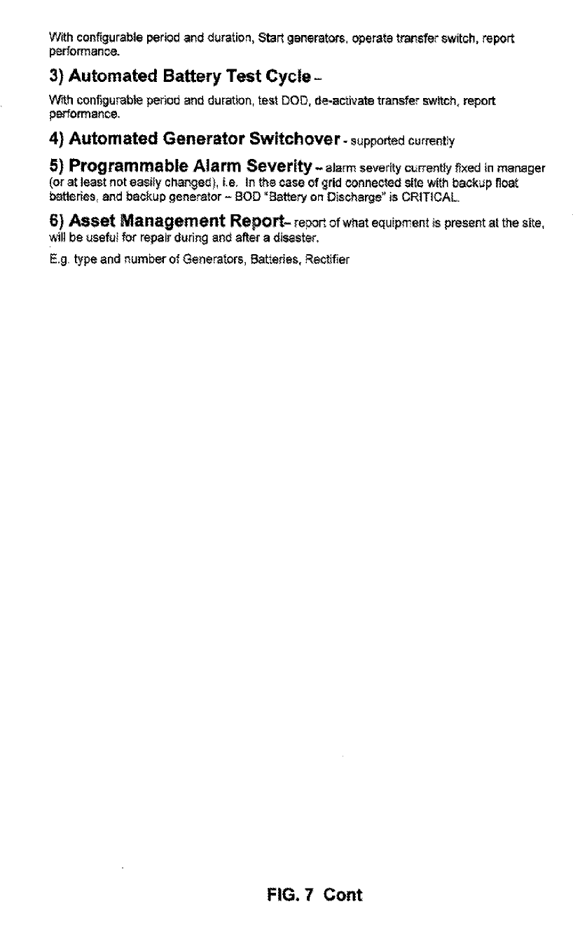

FIG. 7 provides an appendix relating to parameters which may be monitored and reported according to one embodiment.

Aspects and embodiments may be operable to gathering all necessary status information through a single device provided at each base station site.

Aspects and embodiments may be operable to power the single device independently, for example, by means of providing multiple UPS feeds, to the main Telco power systems provided at a site.

Aspects and embodiments may be operable to communicate recorded data to a central server via “redundant” means, for example, ip (DSL), GPRS, satellite modem, rather than use a base station backhaul, since it may be unavailable.

Aspects and embodiments may be operable to record presence or absence of utility power at a base station site. Aspects and embodiments may be operable to record presence or absence of a primary source of grid power at a base station site. Aspects and embodiments may be operable to record presence or absence of one or more secondary sources of grid power at a base station site.

Aspects and embodiments may be operable, in the absence of utility power control site cooling, to implement different criteria to allow conservation of power supply to primary Telco equipment. For example, it may be possible to switch from active cooling mechanisms, such as fan or air conditioning to make use of free air cooling.

Aspects and embodiments may be operable to provide an ability to change site cooling set points to conserve backup power by reducing the electrical load of air conditioning units

Aspects and embodiments may be operable to record operation of automatic transfer switch and generator or fuel cell operation.

Aspects and embodiments may be operable to perform periodic automatic tests of generator capability to start, and supply load at a base station, and record those results.

Aspects and embodiments may be operable to determine whether site is running on batteries.

Aspects and embodiments may be operable to perform periodic testing of backup batteries.

Aspects and embodiments may be operable to record battery operation events and, from measurement of load and battery voltage compared with capacity and previous data, predict how long site may run on batteries.

Aspects and embodiments may be operable to determine whether there is flood water on site.

Aspects and embodiments may be operable to determine whether there is physical damage to a radio mast structure or antennas.

Aspects and embodiments may be operable to record wind speeds to determine likelihood of damage to onsite components, for example, wind turbines.

Aspects and embodiments may be operable to use a camera with image recognition to compare a “normal” image of a mast and antenna system with post disaster images and report and differences, for example by raising an alarm and sending a post-disaster image.

Aspects and embodiments may be operable to determine whether a BTS load is within normal limits.

Aspects and embodiments may be operable to provide an ability to remotely shut down or disconnect some BTS loads to preserve available power for critical services.

Aspects and embodiments may be operable to prioritise sites which have lost utility supply or have other damage for repair visits.

Aspects and embodiments may be operable to group sites regionally and automatically prepare reports in FCC format.

Aspects and embodiments may be operable to allow operator to set periodicity of report generation and then automatically or on manual command send a report, for example, to a third party such as the FCC.

Aspects and embodiments may be operable to provide external access, for example, a browser on Smartphone or PC, to a field repair team, thus allowing such teams to access site status information, and manually update the information if required, and see reports.

Some arrangements recognise that remote sites are often provided with redundant cooling and power systems and may be provided with sophisticated fire and water ingress detection, security monitoring and/or alarm systems. Some aspects and embodiments may allow for remote monitoring of security power or cooling at all times of day. Some aspects and embodiments may make use of that remote monitoring information to provide an indication of the operational status of one or more base station sites within a network.

Remote sites may be provided with an appropriate back-up battery system. Aspects and embodiments recognise that the monitoring method of aspects and embodiments described herein may allow identification of possible base station sites which may advantageously be reconfigured to power, for example, critical communication system apparatus.

Some remote sites may be provided with back-up generators and an appropriate fuel level. Those back-up generators may be provided on hub and/or critical base station sites and may be recognised as being of more significance in a monitoring system according to aspects described herein.

Some remote base station sites may be provided with a solar photovoltaic array, thus allowing substantially indefinite transmission link operation and a power supply for onsite monitoring processes.

Centralized network power management can be critical to managing remote base station sites or standard base station sites within a wireless communication network. Such centralized power management will be of particular use during exceptional circumstances. Monitoring and reporting in accordance with aspects described herein may supplement centralized power management techniques.

An appropriate monitoring method and apparatus may provide an ability to manage thousands of base station sites at a network operation centre and may allow improved network availability and the lowering of operational expenses associated with to management of a wireless communication network.

Some arrangements allow for the control and configuration of base station site power systems from a central operations hub. According to some arrangements, all base station site information may be stored in a relational database. Accordingly, in some arrangements reporting functions can be located at a network operation centre or may be located at a site in the cloud. Some arrangements may allow for all or a subset of all site equipment to be monitored remotely. Some equipment may be remotely controlled or reconfigured. Configuration and software changes may be audited. Updates may be provided over the air. It may be possible, according to some arrangements, to control site power systems remotely, including the switching of power sources on and off. Some methods and apparatus may be configured to support power system load shedding based on load priority to maintain transmission link integrity or to maintain minimum service requirements within a wireless communication network. Arrangements may provide method and apparatus in which a multi-level log-in can be provided. Each log-in level may have a defined level of security and system access to provide access to information from administrators to senior technicians. System functionality may be limited according to a security level associated with each user. Some arrangements may provide for secure communication between each base station site and a central controller or monitoring unit. The exchange of data between a site controller and a monitoring system can be secured by appropriate neutral authentication techniques. Aspects recognise that simple provision of a back-up battery system at each base station site may not be sufficient. Some arrangements provide further environmental and/or operational monitoring to determine the operational status of each base station site. Such an approach may recognise that back-up generators and/or batteries or other electronic devices provided on a base station site may fail.

Some arrangements envisage taking steps to improve transmission network resilience by attempting to ensure that there is no single point of failure. In particular, some arrangements may provide that circuits which form diverse routes through a system do not share cables, cable ducts or buildings, thereby mitigating risks associated with flooding, fire and cable damage. Some base station sites may be provided with at least two diversely routed microwave transmission paths to the switch where possible. Where not possible to connect to site by two microwave lengths, one path may be a terrestrial line or fibre. Microwave antennas may be provided on the same mast and yet have a minimum angle of separation and/or use different frequency bands, thereby providing resilience to local interference and weather conditions. Radio links in transport and communication routes may be such that they do not share masts, thereby mitigating risks associated with weather-damaged masts. End connections in a network may be diverse and separate and routed to different termination points, thereby accounting for flooding, fire, accidental damage or terrorist attack and similar. Rings may be arranged such that they do not share more than one end circuit route with any other ring and redundant cards and/or modules may be used on multiplexes and circuit termination points. According to some arrangements, apparatus may be provided such that all equipment used is separately fused in relation to a main power distribution point in the building, thus minimising the chance of fault propagation and predicting some degree of protection against a single point of failure. Key base station sites may be provided with autonomous generation of power and may be provided with up to 24 hours of battery back-up, photovoltaic cells or appropriate stand-alone power generators.

Some arrangements provide monitoring apparatus comprising: a modem or similar device which is operable to provide an independent backhaul to a central server. That arrangement ensures the apparatus can communicate with a central server, even if a communication network usually supported by any particular base station is not operational. Provision of a modem as part of monitoring apparatus may allow for a network ping over the air to be performed, independently of a radio access technology, thus offering a means to perform an independent RF network integrity check.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The functions of the various elements shown in the Figures, including any functional blocks labelled as “processors” or “logic”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” or “logic” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. A method of monitoring operational status of a plurality of base station sites in a wireless telecommunication network, said method comprising:
receiving an indication of an operational characteristic of at least one power supply provided at least one of said plurality of base station sites;
analyzing said operational characteristic to determine whether said base station site is operational; and
providing an indication of determined operational status in respect of said plurality of base station sites in a wireless telecommunication network.

2. A method according to claim 1, wherein said at least one power supply comprises grid power and analyzing said operational characteristic comprises determining whether said base station site has available grid power.

3. A method according to claim 1, wherein said at least one power supply comprises a supplementary power supply and analyzing said operational characteristic comprises determining whether said base station site has an available supplementary power supply.

4. A method according to claim 1, comprising determining whether said base station site has an available supplementary power supply and, if so, analyzing measured operational parameters at the base station to determine the status of the available supplementary power supply.

5. A method according to claim 1, wherein providing an indication of determined operational status comprises an indication of base station run time based on available power supply.

6. A method according to claim 1, wherein providing an indication of determined operational status comprises an indication of base station failure based on a determination of no available power supply.

7. A computer program product operable, when executed on a computer, to perform the method of claim 1.

8. A monitoring unit operable to monitoring operational status of a plurality of base station sites in a wireless telecommunication network, said monitoring unit comprising:
reception circuitry operable to receive an indication of an operational characteristic of at least one power supply provided at least one of said plurality of base station sites;
analysis circuitry operable to analyze said operational characteristic to determine whether said base station site is operational; and
report circuitry operable to provide an indication of determined operational status in respect of said plurality of base station sites in a wireless telecommunication network.

9. A method according to claim 1, wherein said method comprises: determining an indication of network traffic load supported by said at least one base station site;
analyzing said indication of network traffic load and said operational characteristic of at least one power supply to provide an indication of an operational status of said base station site.

10. A method according to claim 1, wherein said method comprises:
determining an indication of an environmental condition of said at least one base station site; and
analyzing said indication of environmental condition and said operational characteristic of at least one power supply to provide an indication of an operational status of said base station site.

11. A method according to claim 1, comprising:
transmitting a wireless signal, determining whether at least one of said plurality of base station sites is operable to receive said wireless signal.

12. A method according to claim 1, comprising:
monitoring for a pilot signal from said at least one of said plurality of base station sites; and
analyzing monitoring results in conjunction with said operational characteristic of at least one power supply to provide an indication of an operational status of said base station site.

13. A method according to claim 1, wherein said plurality of base station sites comprise base stations operating across at least two radio access technologies.

14. A method according to claim 1, comprising:
periodically receiving said indication of an operational characteristic of at least one power supply.
